(19) United States
(12) Patent Application Publication
(10) Pub. No.: US 2009/0297336 A1
(43) Pub. Date: Dec. 3, 2009

(54) ONLINE SYSTEMS AND METHODS FOR THERMAL INSPECTION OF PARTS

(75) Inventors: Jason Randolph Allen, Niskayuna, NY (US); Ronald Scott Bunker, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 11/842,219

(22) Filed: Aug. 21, 2007

(51) Int. Cl. F01D 25/00; G01F 1/68

(52) U.S. Cl. 415/118; 702/49

(57) ABSTRACT

A thermal inspection method is provided. The method includes measuring a transient thermal response of a cooled part installed in a turbine engine, wherein the transient thermal response results from operation of the turbine engine. The method also includes using the transient thermal response to determine one or more of a flow rate of a fluid flowing through one or more film cooling holes in the cooled part during operation of the turbine engine, at least one heat transfer coefficient for one or more internal passages in the cooled part, and a combined thermal response for the cooled part. The method further includes comparing at least one of the flow rate, the at least one heat transfer coefficient, and the combined thermal response of at least a portion of the cooled part to at least one baseline value to determine whether a thermal performance of the cooled part is satisfactory.

### BACKGROUND

The invention relates generally to thermal inspection systems and methods and more specifically, to non-destructive thermal inspection of cooled parts during operation of the system.

There are several techniques that are currently used for inspection of cooled parts for internal cavities. A commonly used technique is “flow checks”. A flow check measures a total flow through a part. The measurement is made for a group of film holes by blocking a remaining group of film holes or rows of holes. The process is repeated with various holes or passages blocked until all desired measurements have been made. Comparisons to either gauge measurements on reliable parts or to analytical models of flow circuits determines the acceptability of the parts. However, the technique is known to be time consuming resulting in a check of only selective film holes, groups of holes, or flow circuits. Additionally, the technique has the propensity to overlook local or individual features or holes that are out of specification.

Other techniques include dimensional gauges, for example pin checks, and other visual methods, for example water flow. However, the aforementioned techniques are employed before the parts enter service and not during operation. During operation, parts such as, but not limited to, airfoils with film holes and internal cooling cavities are subject to blockage from ingested debris by the engine or other damage resulting in diminished film effectiveness and/or thermal performance. While internal damage may be seen during visual inspections offline, they cannot be visually detected online. As used herein, the term ‘visual’ refers to damage observable in a visible wavelength spectrum. Further, the term ‘damage’ includes changes to a physical appearance or dimension of the part and changes in thermal performance of the part due to reasons such as, but not limited to, blockages, debris, foreign object damage, oxidation, corrosion and loss of protective coating.

Accordingly, there is a need for an improved method of thermal inspection and specifically, there is a need for a non-destructive thermal inspection system and method during operation.

### BRIEF DESCRIPTION

In accordance with an embodiment of the invention, a thermal inspection method is provided. The method includes measuring a transient thermal response of a cooled part installed in a turbine engine, wherein the transient thermal response results from operation of the turbine engine. The method also includes using the transient thermal response to determine one or more of a flow rate of a fluid flowing through one or more film cooling holes in the cooled part during operation of the turbine engine, at least one heat transfer coefficient for one or more internal passages in the cooled part, and a combined thermal response for the cooled part. The method further includes comparing at least one of the flow rate, the at least one heat transfer coefficient, and the combined thermal response of at least a portion of the cooled part to at least one baseline value to determine whether a thermal performance of the cooled part is satisfactory.

In accordance with another embodiment of the invention, a thermal inspection method is provided. The method includes measuring multiple transient thermal responses of a respective number of cooled parts installed in a turbine engine, wherein the transient thermal responses result from operation of the turbine engine. The method also includes using the transient thermal responses to determine at least one of a respective flow rate of a fluid flowing through one or more film cooling holes on each of the cooled parts during operation of the turbine engine, at least one heat transfer coefficient for one or more internal passages in each of the cooled parts, and a respective combined thermal response for each of the cooled parts. The method also includes comparing at least one of the flow rates, the heat transfer coefficients and the combined thermal responses of at least a portion of each of the cooled parts to determine whether a respective thermal performance of each of the cooled parts is satisfactory.

In accordance with another embodiment of the invention, a system for thermal inspection of a cooled part installed in a turbine engine is provided. The system includes a thermal monitoring device configured to detect at least one surface temperature, either directly or indirectly, of the cooled part at multiple times corresponding to a transient thermal response of the cooled part, wherein the transient thermal response results from operation of the turbine engine. The system also includes a processor configured to determine based upon the transient thermal response one or more of a flow rate of a fluid flowing through one or more film cooling holes in the cooled part during operation of the turbine engine, at least one heat transfer coefficient for one or more internal passages in the cooled part and a combined thermal response for the cooled part. The processor is also configured to compare at least one of the flow rate, the at least one heat transfer coefficient, and the combined thermal response of at least a portion of the cooled part to at least one baseline value to determine whether a thermal performance of the cooled part is satisfactory.

In accordance with another embodiment of the invention, a system for thermal inspection of multiple cooled parts installed in a turbine engine is provided. The system includes a thermal monitoring device configured to detect a plurality of surface temperatures, either directly or indirectly, of each of the cooled parts corresponding to a transient thermal response of each of the cooled parts, wherein the transient thermal response results from operation of the turbine engine. The system also includes a processor configured to determine based upon the transient thermal responses one or more of a flow rate of a fluid flowing through one or more film cooling holes in each of the cooled parts during operation of the turbine engine, at least one heat transfer coefficient for one or more internal passages in each of the cooled parts, and a combined thermal response for each of the cooled parts. The processor is also configured to compare at least one of the flow rate, the at least one heat transfer coefficient, and the combined thermal response of at least a portion of each of the cooled parts to determine whether a thermal performance of each of the cooled parts is satisfactory.

### DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of a gas turbine engine having air cooled turbine vane and blade airfoils;

FIG. 2 is an enlarged cross-sectional view of a portion of the turbine in FIG. 1;

FIG. 3 is a schematic illustration of an exemplary film cooled airfoil or part in the engine in FIG. 1 including two exemplary rows of film cooling holes and a thermal monitoring device in accordance with embodiments of the invention;

FIG. 4 is a cross-sectional view of the part in FIG. 1;

FIG. 5 is an enlarged view of the exemplary film cooled hole in FIG. 3;

FIG. 6 is a diagrammatical illustration of the part in FIG. 1 employing internal cooling passages;

FIG. 7 is a diagrammatical illustration of an exemplary thermal inspection system including an infrared camera for thermal inspection of a blade during operation of a turbine engine in accordance with embodiments of the invention;

FIG. 8 is a diagrammatical illustration of an exemplary thermal inspection system including an actuating infrared pyrometer for thermal inspection of a blade during operation of a turbine engine in accordance with embodiments of the invention;

FIG. 9 is diagrammatical illustration of an exemplary thermal inspection system including a single line infrared pyrometer for thermal inspection of a blade during operation of a turbine engine in accordance with embodiments of the invention;

FIG. 10 is a flow chart representing steps in an exemplary method for thermal inspection of a cooled part in accordance with embodiments of the invention; and

FIG. 11 is a flow chart representing steps in another exemplary method for thermal inspection of a cooled part in accordance with embodiments of the invention.

### DETAILED DESCRIPTION

As described in detail below, embodiments of the invention are directed to online systems and methods for thermal inspection of one or more cooled parts during operation of an engine. Example ‘parts’ include equipment used in engine systems such as, but not limited to, turbine engines. As used herein, the term ‘online system and method’ refers to a system and method that inspects the parts during operation of an engine in a real environment such as, among others, a hot gas flowing over the part under real temperatures, real pressures and real hot gas characteristics. Further, the phrase “operation of an engine” should be understood to encompass any operation of the engine, including but not limited to start-up and steady state operation. As used herein, the term “cooled part’ refers to parts equipped with internal cooling passages and/or with film cooling holes and associated passages.

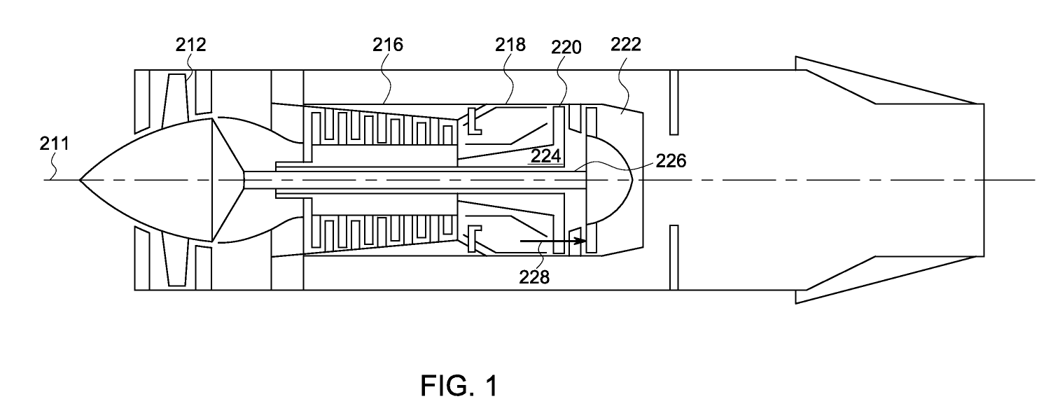

Turning to the drawings, FIG. 1 is an exemplary gas turbine engine 210 circumferentially disposed about an engine centerline 211 and having in serial flow relationship a fan section indicated by a fan section 212, a high pressure compressor 216, a combustion section 218, a high pressure turbine 220, and a low pressure turbine 222. The combustion section 218, the high pressure turbine 220, and low pressure turbine 222 are often referred to as the hot section of the engine 210. A high pressure rotor shaft 224 connects, in driving relationship, the high pressure turbine 220 to the high pressure compressor 216 and a low pressure rotor shaft 226 drivingly connects the low pressure turbine 222 to the fan section 212. Fuel is burned in the combustion section 218 producing a very hot gas flow 228 which is directed through the high pressure and low pressure turbines 220 and 222 respectively to power the engine 210.

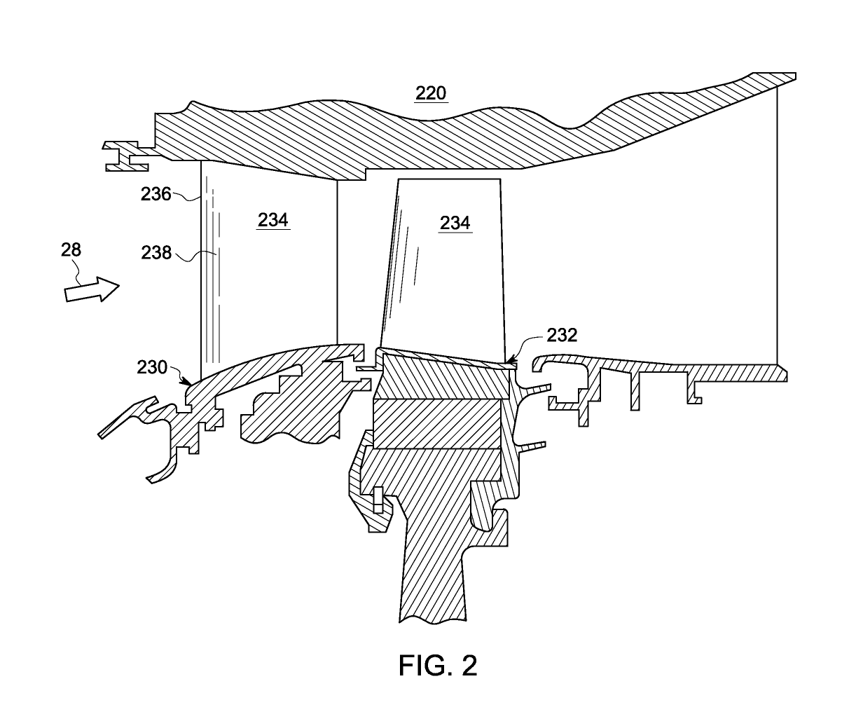

FIG. 2 illustrates the high pressure turbine 220 having a turbine vane 230 and a turbine blade 232. An exemplary airfoil 234 may be used for either or both the turbine vane 230 and the turbine blade 232. The airfoil 234 has an outer wall 236 with a hot wetted surface 238 which is exposed to the hot gas flow 228. Turbine vanes 230, and in many cases turbine blades 232, are often cooled by air routed from the fan or one or more stages of the compressors (through a platform 241 of the turbine vane 230).

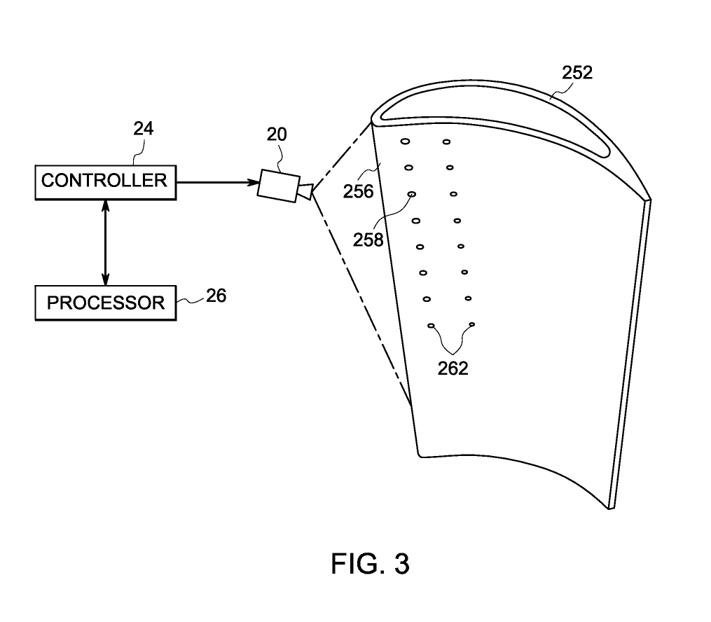

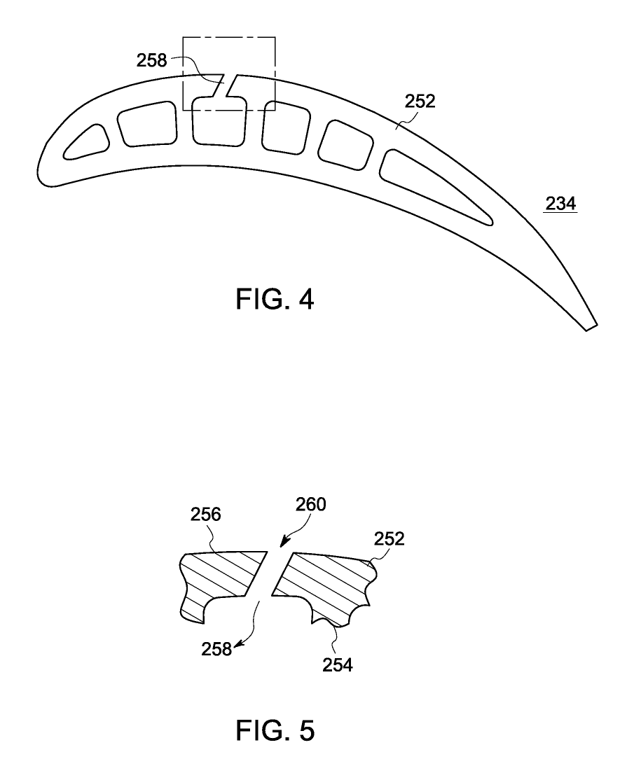

The part or airfoil 234 with film cooling is described with respect to FIGS. 3-6. Exemplary film cooled components include hot gas path components in turbines, for example stationary vanes (nozzles), turbine blade (rotors), combustion liners, other combustion system components, transition pieces, and shrouds. The airfoil 234 is shown in cross-section in FIG. 4. The part 234 includes a wall 252 having a cold surface 254 and a hot surface 256. At least one film-cooling hole 258 extends through the wall 252 for flowing a coolant from the cold surface 254 to the hot surface 256. An exemplary film-cooling hole 258 is shown in an enlarged view in FIG. 5. An exemplary coolant is air, for example compressed air. It should be noted that the terms “hot” and “cold” surfaces are relative. As used here, the hot surface 256 is the surface of the wall 252 exposed to hot gases, and the cold surface 254 is the surface from which the coolant flows. As indicated in FIG. 3, the film-cooling hole is typically angled relative to the hot surface 256 and the cold surface 254. Beneficially, an angled film-cooling hole 258 provides a longer cooling length for a given wall thickness. However, for certain applications, straight film-cooling holes 258 may be employed. As shown in FIG. 5, the film-cooling hole 258 defines an exit site 260 in the hot surface 256 of the wall 252. Coolant exits the film-cooling hole 258 through the exit site 260

The coolant provides a protective barrier that reduces the contact between the hot gases and the wall 252. The number of film-cooling holes 258 formed in the part 234 depends on the amount of cooling needed. The amount of cooling required depends on the application, for example stationary power generation or aircraft engine applications, as well as on the position of the part 234 in the turbine engine, for example whether the part 234 is in stage 1 or stage 2 of the turbine engine. For heavily cooled parts, for example airfoils positioned immediately after the combustion section (not shown), which see the hottest gases, on the order of 700 film-cooling holes 258 may be formed in the wall 252 of the airfoil 234. For components requiring less cooling, a few film-cooling holes 258 may suffice, and for intermediate levels of cooling, a few rows 262 of the film-cooling holes 258 (corresponding to around sixty film-cooling holes 258) are used. Accordingly, the two rows 262 of film-cooling holes 258 shown in FIG. 3 are purely illustrative, with respect to both the desired number and positions of the film-cooling holes 258.

A thermal monitoring device 20 is employed to detect at least one surface temperature, either directly or indirectly, of the cooled part 234 at multiple times corresponding to a transient thermal response of the part 234 that results from operation of the turbine engine. As used herein, the term “transient thermal response” includes one or more local thermal responses of the part 234, or spatial thermal responses of regions of the part 234, or the entire part 234. Further, the term “indirectly” as used herein, should be understood to encompass detecting at least one surface temperature by measuring radiance and performing a necessary conversion or calibration to obtain the temperature. In a particular embodiment, the thermal monitoring device 20 includes an infrared detection device such as, but not limited to, an infrared camera, an actuating pyrometer, and a single point pyrometer. In another embodiment, the thermal monitoring device 20 is an infrared camera. A controller 24 is configured to control and automate movement of the thermal monitoring device 20 (or movement of a sensor or optical piece, for example a prism).

During operation of the turbine engine 210 (FIG. 1), there are a number of predictable and unpredictable transients in operating conditions. In order to be aware of the operating conditions, multiple parameters are measured under these conditions. For example, during operation of a heavy duty gas turbine, the cooled part 234 goes through transient thermal changes in terms of a hot gas flow path. However, parameters corresponding to the thermal changes of the hot gas flow path on the cooled part 234 may be measured. Accordingly, the transient thermal response recorded from the thermal monitoring device 20 enables determining via a processor 26 one or more parameters under the operating conditions such as, but not limited to, a flow rate of a fluid through the cooling hole 258 during operation of the engine, at least one heat transfer coefficient for one or more cooled passages in the cooled part 234, and a combined thermal response of the cooled part 234. As used herein, the term “combined thermal response” reflects all thermal influences for the cooled part 234, including but not limited to all internal cooling and material conduction and thermal diffusivity effects resulting from internal ribs, film holes, internal bumps, crossover holes, and other features. Further, the term ‘flow rate’ is understood to encompass an actual quantity and a flow rate characteristic such as, but not limited to, a flow coefficient. In another embodiment, the processor 26 determines the rate of change of a thermal performance of the cooled part 234 based upon the transient thermal response.

The parameters measured via the processor 26 are further compared to one or more baseline values to determine adequacy of the cooled part 234. Non-limiting examples of the baseline values are one or more local values, mean value of a group of local values and a standard deviation of a group of local values. There are various stages at which the baseline values may be defined. In one embodiment, measurements performed during operation of an engine when the cooled part 234 is in a “new” and an optimal condition prior to any degradation effects form a baseline for subsequent measurements performed. In another embodiment, the baseline values are obtained by performing a transient thermal analysis prior to installation of the cooled part 234 on the turbine engine, for example, by performing multiple bench tests on the cooled part 234. In yet another embodiment, the baseline values are redefined by obtaining and analyzing measurements taken during any point in-service; such a redefined baseline would act as a comparison data for subsequent measurements going forward in time.

It should be noted that the present invention is not limited to any particular processor for performing the processing tasks of the invention. The term “processor,” as that term is used herein, is intended to denote any machine capable of performing the calculations, or computations, necessary to perform the tasks of the invention. The term “processor” is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of the invention, as will be understood by those skilled in the art.

In an exemplary embodiment, wherein the engine may include multiple cooled parts 234, a system for thermal inspection of the multiple cooled parts 234 is provided. In such an embodiment, the thermal monitoring device 20 detects multiple surface temperatures, either directly or indirectly, of each of the cooled parts 234 corresponding to a transient thermal response of each of the cooled parts 234 resulting from operation of the engine. Furthermore, the processor 26 determines based upon the transient thermal responses one or more of a flow rate of a fluid flowing through one or more film cooling holes in each of the cooled parts during operation of the turbine engine, at least one heat transfer coefficient for one or more internal passages in each of the cooled parts 234, and a combined thermal response for each of the cooled parts 234. In addition, the processor 26 compares at least one of the flow rate, the heat transfer coefficient, and the combined thermal response of each of the cooled parts 234 to determine whether a thermal performance of each of the cooled parts 234 is satisfactory. In another embodiment, a rate of change of the thermal response of each of the cooled parts 234 is compared. Such a system allows comparison of thermal performance between parts. In an example, a thermal response of 100 blades in a rotor during operation may be compared with each other and monitored for a long period of time to detect an anomaly in a specific part. If a specific blade is found to be deteriorating in thermal performance compared to the other blades, the blade may be replaced in time to avoid any further damage.

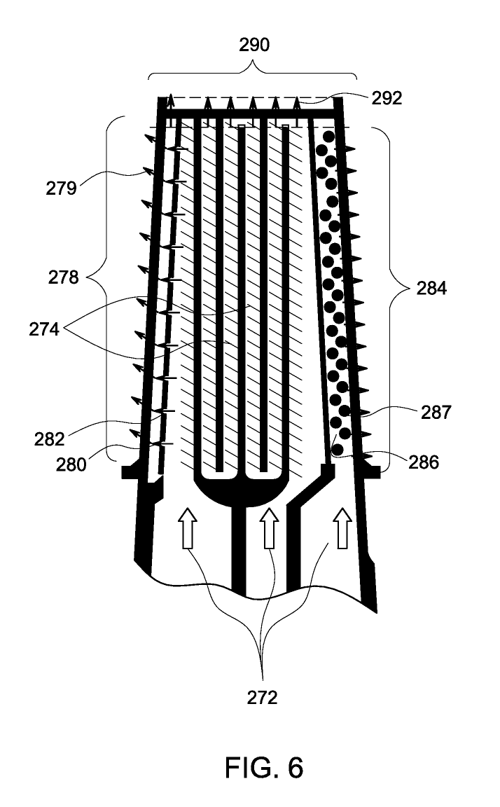

FIG. 6 is a diagrammatical illustration of the blade 234 with multiple cooling circuits 272 that each branch out into a number of internal cooling passages 274. In the illustrated embodiment, the blade 234 includes three cooling circuits 272, one of which branches out into five internal cooling passages 274. The internal cooling passages 274 cool a bulk portion of the blade 234. A leading edge 278 of the blade 234 is cooled via a radial passage indicated by arrows 280 impinging through a number of crossover holes 282. The leading edge 278 is also cooled via film cooling indicated by arrows 279. A trailing edge 284 of the blade 234 is cooled via a radial pin-bank array 286 and multiple ejection channels 287. Similarly, a tip 290 of the blade 234 is cooled via film cooling indicated by arrows 292. Some non-limiting examples of internal cooling technologies include turbulators, pin-fins, turns, impingement jets, trailing edge holes, swirl cooling, vortex cooling, convoluted passages, and tip purge holes. The number, cross-sectional shape, and sizing of the internal cooling passages 244 may vary considerably.

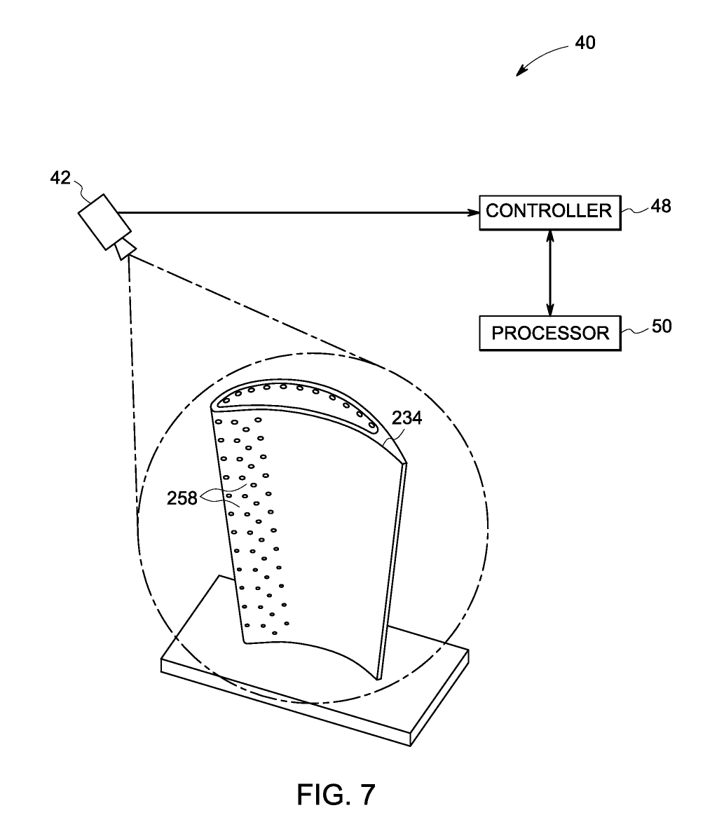

FIG. 7 is a diagrammatical illustration of an exemplary thermal detection system 40 including an imaging infrared camera 42 for thermal inspection of a blade 234 (FIG. 3) during operation of a turbine engine 210 as referenced in FIG. 1 The infrared camera 42 captures an image of the blade 234 having multiple film cooling holes 258. The image captured enables recording of a transient thermal response of the blade 234 during operation of the engine. The camera 42 is coupled to a controller 48 and a processor 50 that control and automate movement of the camera 42. Further, the controller 48 also enables temperature data acquisition and controls functionalities such as, but not limited to, frame rate, timing with respect to rotor indexing, focusing and frame size.

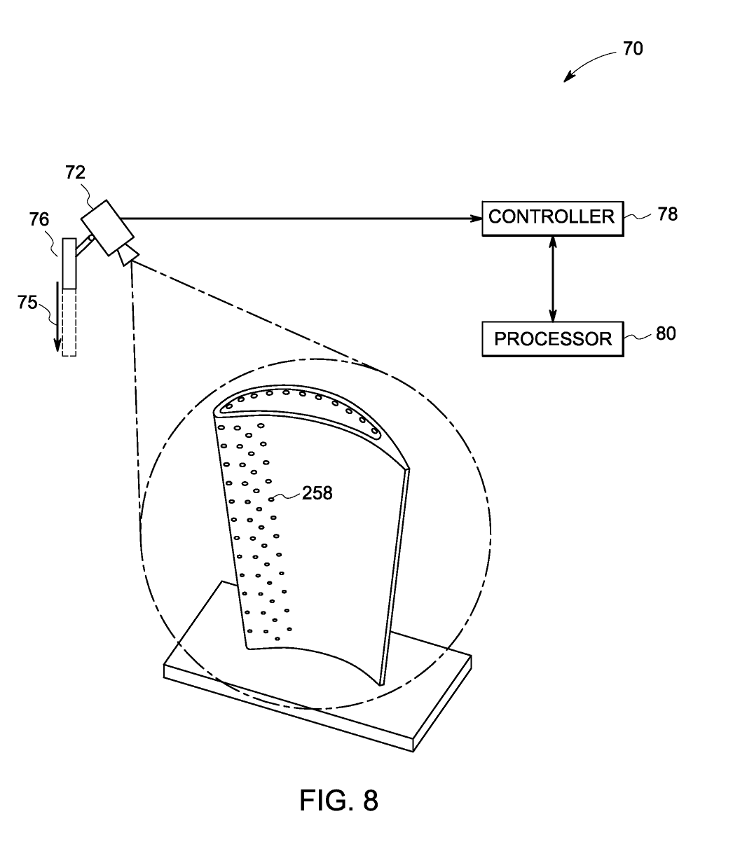

FIG. 8 is a diagrammatical illustration of an exemplary thermal detection system 70 including an actuating pyrometer 72 for thermal inspection of the blade 234 during operation of an engine. The pyrometer 72 includes an optical probe 76 that is traversed along a path 75 providing a full view of the blade 234 having multiple cooling holes 258. The pyrometer 72 is coupled to a controller 78 and a processor 80 that control and automate movement of the pyrometer 72.

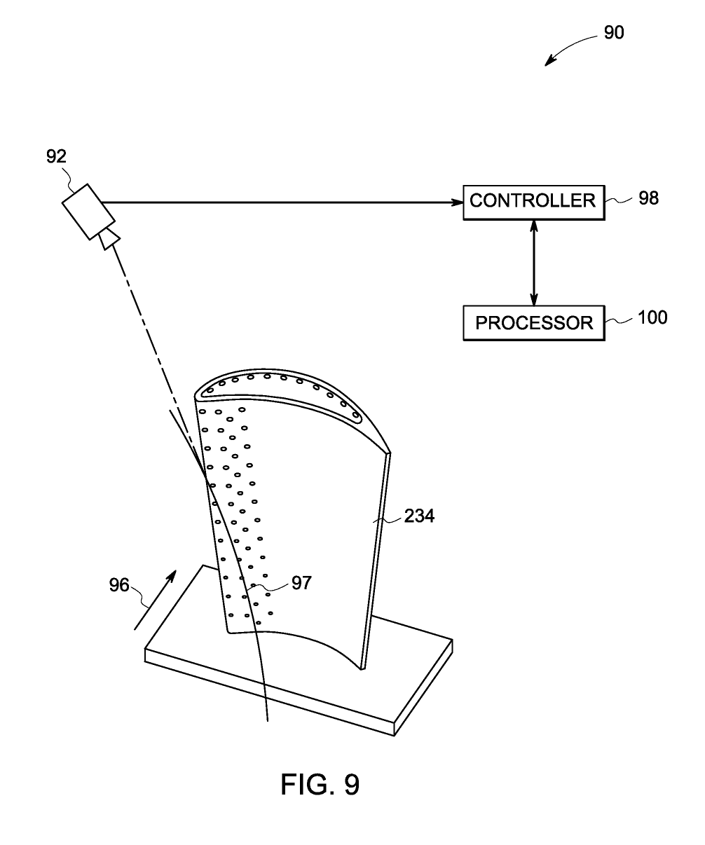

FIG. 9 is a diagrammatical illustration of another exemplary thermal detection system 90 including a single line infrared pyrometer 92 for thermal inspection of the blade 234 during operation of an engine. The single line infrared pyrometer 92 records a single point on a static component and a line of data on a rotating component. In a particular embodiment, when the blade 234 is rotating in a direction 96, the single line infrared pyrometer 92 records data along a line 97. The single line infrared pyrometer 92 is coupled to a controller 98 and a processor 100 that control and automate movement of the pyrometer 92.

Data obtained by the foregoing detection systems may be analyzed by various means. In one embodiment, a surface map of the cooled part 234 is obtained from a first derivative and/or a second derivative of temperature variation with respect to time due to operation of the engine. It should be appreciated that the use of a first derivative and/or a second derivative of temperature also apply when determining other parameters such as, but not limited to, the film hole flow rate, the internal heat transfer coefficient, and the combined thermal response. In another embodiment, at least one measurement location or region may be obtained. This also enables determination of a combined thermal response, the flow rate and the heat transfer coefficient. Further details of the analysis can be found in co-pending U.S. patent application Ser. No. 11/775,502 entitled “SYSTEM AND METHOD FOR THERMAL INSPECTION OF PARTS”, filed on Jul. 10, 2007 and assigned to the same assignee as this application, the entirety of which is hereby incorporated by reference herein. Further details of the analysis may be obtained in U.S. Pat. No. 6,732,582B2 entitled “METHOD FOR QUANTIFYING FILM HOLE FLOW RATES FOR FILM-COOLED PARTS”, filed on Aug. 23, 2002 and assigned to the same assignee as this application, the entirety of which is hereby incorporated by reference herein.

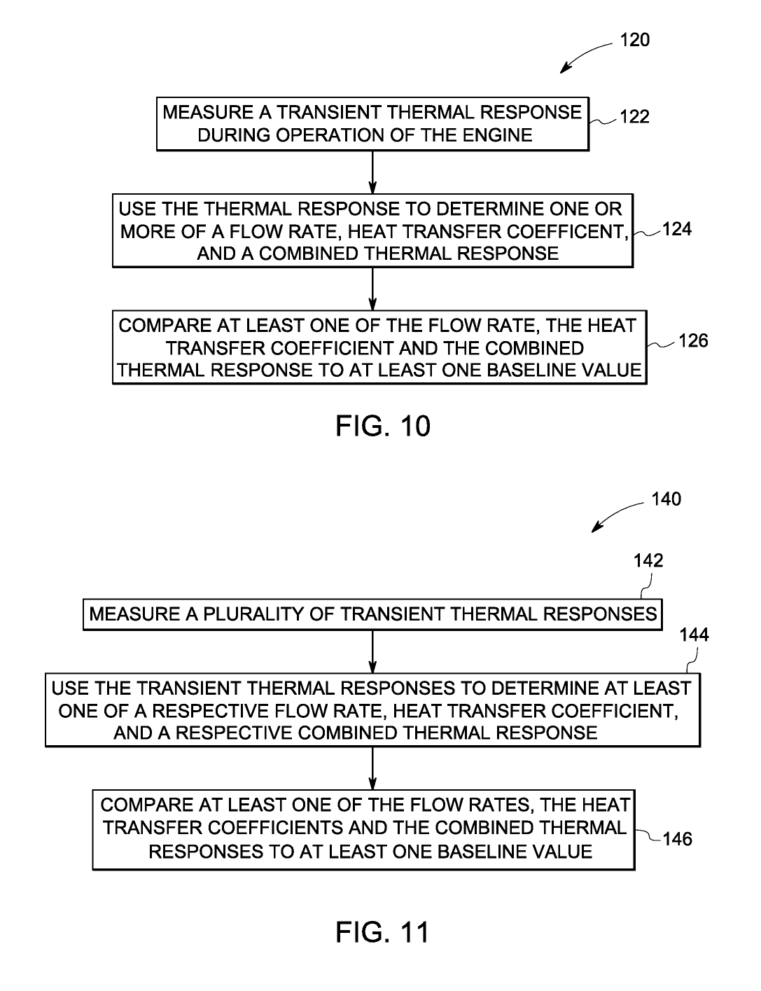

FIG. 10 is a flow chart representing steps in an exemplary method 120 for thermal inspection of a cooled part. The method 120 includes measuring a transient thermal response of a cooled part installed in a turbine engine, wherein the thermal response results from operation of the turbine engine in step 122. In a particular embodiment, at least one surface temperature is detected, either directly or indirectly, at multiple times. In an example, the surface temperature is detected via infrared detection. Non-limiting example devices for infrared detection include a line-of-sight pyrometer, an articulating pyrometer, a single point pyrometer and an imaging camera. The thermal response measured is used to determine one or more parameters in step 124. The parameters include, among others, a flow rate of a fluid flowing through one or more cooling holes in the cooled part during operation of the turbine engine, at least one heat transfer coefficient for one or more internal passages in the cooled part, and a combined thermal response for at least one of one or more points, one or more regions, or a whole of the cooled part. In a particular embodiment, the combined thermal response is determined using temperature or radiance measured. In another embodiment, a temperature is measured at one or more locations on the cooled part over time and the combined thermal response is determined by calculating at least one of a first and a second derivative of the temperature with respect to time.

Further, the aforementioned parameters are compared to at least one baseline value in step 126 to determine whether a thermal performance of the cooled part is satisfactory. In one embodiment, the baseline value is determined by measuring a baseline transient thermal response of the cooled part prior to introducing the cooled part in service. In a particular embodiment, the cooled part is a film cooled part and the thermal transient response is used to determine the flow rate of the fluid flowing through one or more film cooling holes in the film cooled part during operation of the engine, and the flow rate is compared to the baseline value to determine whether the one or more film cooling holes meet one or more specifications. Non-limiting examples of the term ‘meet one or more specifications’ include avoiding partial or total blockage from deposits that may build up on an exterior surface of the airfoil resulting in a partial or total blockage of the hole from outside, and a correct film hole size. In another embodiment, the combined thermal response is compared to a baseline value by comparing at least one of the temperature or radiance, or the first or the second derivative of such, to the at least one baseline value to determine if the cooled part meets a desired specification. In yet another embodiment, the cooled part includes at least one internal passage, and the transient thermal response is used to determine at least one heat transfer coefficient for the at least one internal passage, and wherein the at least one heat transfer coefficient is compared to the at least one baseline value to determine whether one or more internal passages meet one or more specifications. Non-limiting examples of the term ‘meet one or more specifications’ used herein include avoiding an improper formation of the passage such as left over slag from a casting operation, debris from cleaning processes, and avoiding improper dimensions that result in a partial or total blockage of the internal passage.

FIG. 11 is a flow chart representing steps in an exemplary method 140 for thermal inspection of multiple cooled parts. The method 140 includes measuring multiple transient thermal responses of a respective number of cooled parts installed in a turbine engine, wherein the transient thermal responses result from operation of the turbine engine in step 142. In a particular embodiment, thermal data is obtained, either directly or indirectly, for each of the cooled parts at multiple times. In an example, the thermal data is obtained using a single point pyrometer. In another example, the thermal data is obtained by obtaining multiple infrared images of each of the cooled parts. The thermal response measured for each part is used to determine one or more parameters for each part in step 144. The parameters include, among others, a flow rate of a fluid flowing through one or more cooling holes in the cooled part during operation of the turbine engine, at least one heat transfer coefficient for one or more internal passages in the cooled part, and a combined thermal response for the cooled part. In a particular embodiment, the thermal response is measured at a point on an external surface of respective ones of the film cooled parts that is near a cooling hole. In another embodiment, a temperature is measured at one or more locations on the cooled part over time and the combined thermal response is determined by calculating at least one of a first and a second derivative of the temperature with respect to time.

Further, the aforementioned parameters are compared to at least one baseline value in step 146 to determine whether a thermal performance of each of the cooled parts is satisfactory. In one embodiment, the baseline value(s) is determined by measuring a baseline transient thermal response of one or more of the cooled parts prior to introducing the cooled parts in service. In a particular embodiment, the cooled parts are film cooled parts and the transient thermal responses are used to determine the respective flow rates of the fluid flowing through one or more film cooling holes in the film cooled parts during operation of the engine, and the flow rates are compared to the baseline value to determine whether the one or more film cooling holes in respective ones of the film cooled parts are either obstructed or are not receiving a desired amount of flow. As used here “obstructed” includes both partial and full obstruction of the film holes or passageways. In yet another embodiment, the combined thermal response for each of the cooled parts is compared to a baseline value by comparing at least one of the first or the second derivative to the at least one baseline value to determine if respective ones of the cooled parts meet a desired specification.

In one example, a statistical measure associated with the flow rate for the film cooled parts is determined and each of the flow rates of respective cooled parts are compared to the statistical measure. A difference between each of the flow rates and the statistical measure is computed to determine the variance and/or to check whether the difference exceeds a pre-determined value. As used herein, a pre-determined value refers to a desired or a specified value. Non-limiting examples of the statistical measure include a mean and standard deviation. In another example, at least one statistical measure associated with the heat transfer coefficient is determined for internal passages in each of the cooled parts and the statistical measure is compared to each of the heat transfer coefficients of each of the cooled parts to determine if a difference between them lies within specification limits and/or to determine the variance. In yet another example, at least one statistical measure associated with the combined thermal response for the cooled parts is determined and compared to each of the combined thermal responses of each of the cooled parts to determine the variance and/or to determine whether a difference between the statistical measure and respective combined thermal responses lies within specification limits.

The various embodiments of an online system and method for thermal inspection of parts described above thus provide a way to measure individual and combined thermal response of all thermal influences in a part during operation. These techniques and systems also allow for improved turbine prognosis and field inspection techniques. In addition, the present techniques may contribute to high quality turbine reliability and operability. Further, online measurements coupled with manufacturing inspection results provide a complete history on an entire part as well as individual portions of parts such as, but not limited to, cooling holes.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of an example of a camera described with respect to one embodiment can be adapted for use in a system used for thermal inspection of multiple parts described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A thermal inspection method comprising:
measuring a transient thermal response of a cooled part installed in a turbine engine, wherein the transient thermal response results from operation of the turbine engine;
using the transient thermal response to determine one or more of:
a flow rate of a fluid flowing through one or more film cooling holes in the cooled part during operation of the turbine engine,
at least one heat transfer coefficient for one or more internal passages in the cooled part, and
a combined thermal response for the cooled part; and
comparing at least one of the flow rate, the at least one heat transfer coefficient, and the combined thermal response of at least a portion of the cooled part to at least one baseline value to determine whether a thermal performance of the cooled part is satisfactory.

2. The thermal inspection method of claim 1, wherein the measuring step comprises detecting at least one surface temperature either directly or indirectly, of the cooled part at a plurality of times.

3. The thermal inspection method of claim 2, wherein the detecting comprises infrared detection.

4. The thermal inspection method of claim 1, further comprising determining the at least one baseline value by:
measuring a baseline transient thermal response for at least a portion of the cooled part, and
using the baseline transient thermal response to determine one or more of: a baseline flow rate, one or more baseline heat transfer coefficients, and a baseline combined thermal response for at least a portion of the cooled part.

5. The thermal inspection method of claim 1, wherein the cooled part comprises a film cooled part, wherein the transient thermal response is used to determine the flow rate of the fluid flowing through the one or more film cooling holes in the film cooled part during operation of the turbine engine, and wherein the flow rate is compared to the baseline value to determine whether the one or more film cooling holes meet one or more specifications.

6. The thermal inspection method of claim 1, wherein the cooled part comprises at least one internal passage, wherein the transient thermal response is used to determine at least one heat transfer coefficient for the at least one internal passage, and wherein the at least one heat transfer coefficient is compared to the at least one baseline value to determine whether the one or more internal passages meet one or more specifications.

7. The thermal inspection method of claim 1, wherein the transient thermal response is used to determine the combined thermal performance at one or more points on the cooled part, for one or more regions on the cooled part, or for the entire cooled part.

8. The thermal inspection method of claim 7, wherein the measuring step comprises measuring a radiance at one or more locations on the cooled part over time, and wherein determining the combined thermal response for the cooled part is determined using the radiance.

9. The thermal inspection method of claim 7, wherein the measuring step comprises measuring a temperature at one or more locations on the cooled part over time, wherein determining the combined thermal response for the cooled part comprises calculating at least one of a first and a second derivative of the temperature with respect to time, and wherein the step of comparing the combined thermal response to the at least one baseline value comprises comparing at least one of the first or the second derivative to the at least one baseline value to determine if the cooled part meets a desired specification.

10. A thermal inspection method comprising:
measuring a plurality of transient thermal responses of a respective plurality of cooled parts installed in a turbine engine, wherein the transient thermal responses result from operation of the turbine engine;
using the transient thermal responses to determine at least one of:
a respective flow rate of a fluid flowing through one or more film cooling holes on each of the cooled parts during operation of the turbine engine,
at least one heat transfer coefficient for one or more internal passages in each of the cooled parts, and
a respective combined thermal response for each of the cooled parts; and
comparing at least one of the flow rates, the heat transfer coefficients and the combined thermal responses of at least a portion of each of the cooled parts to at least one baseline value to determine whether a respective thermal performance of each of the cooled parts is satisfactory.

11. The thermal inspection method of claim 10, wherein the measuring step comprises obtaining a plurality of thermal data of each of the cooled parts at a plurality of times.

12. The thermal inspection method of claim 10, wherein the cooled parts are film cooled parts, wherein the transient thermal responses are used to determine the respective flow rates of the fluid flowing through one or more of the film cooling holes in the film cooled parts during operation of the turbine engine, and wherein the flow rates are used to determine whether one or more of the film cooling holes in respective ones of the film cooled parts meet one or more specifications.

13. The thermal inspection method of claim 12, further comprising determining a statistical measure associated with a flow rate for the film cooled parts, wherein the comparing comprises comparing each of the flow rates to the statistical measure and determining whether a difference between each of the flow rates and the statistical measure exceeds a pre-determined value.

14. The thermal inspection method of claim 10, wherein each of the cooled parts comprises at least one internal passage, wherein the transient thermal responses are used to determine at least one heat transfer coefficient for respective ones of the at least one internal passage, and wherein the heat transfer coefficients are compared to the at least one baseline value to determine whether one or more of the internal passages meet one or more specifications.

15. The thermal inspection method of claim 14, further comprising determining a statistical measure of the heat transfer coefficient for the internal passages, wherein the comparing comprises comparing each of the heat transfer coefficients to the statistical measure and determining whether a difference between each of the heat transfer coefficients and the statistical measure exceeds a pre-determined value.

16. The thermal inspection method of claim 10, wherein the transient thermal responses are used to determine the respective combined thermal response at one or more points on the respective cooled parts, for one or more regions on the respective cooled parts, or for the entire of the cooled parts.

17. The thermal inspection method of claim 16, further comprising determining a statistical measure of the combined thermal response for the cooled parts, wherein the comparing comprises comparing each of the combined thermal responses to the statistical measure and determining whether a difference between each of the combined thermal responses and the statistical measure exceeds a pre-determined value.

18. The thermal inspection method of claim 10, wherein the measuring step comprises measuring a radiance at one or more locations on the cooled part over time, wherein determining the combined thermal response for the cooled part is determined using the radiance.

19. The thermal inspection method of claim 10, wherein the measuring step comprises measuring a temperature at one or more locations on each of the cooled parts over time, wherein determining the combined thermal response for each of the cooled parts comprises calculating at least one of a first and a second derivative of the temperature with respect to time, and wherein the step of comparing the combined thermal responses comprises comparing at least one of the first or the second derivatives to determine if respective ones of the cooled parts meet a desired specification.

20. A system for thermal inspection of a cooled part installed in a turbine engine, the system comprising:
a thermal monitoring device configured to detect at least one surface temperature, either directly or indirectly, of the cooled part at a plurality of times corresponding to a transient thermal response of the cooled part, wherein the transient thermal response results from operation of the turbine engine; and
a processor configured to:
determine based upon the transient thermal response one or more of:
a flow rate of a fluid flowing through one or more film cooling holes in the cooled part during operation of the turbine engine,
at least one heat transfer coefficient for one or more internal passages in the cooled part, and
a combined thermal response for the cooled part; and
compare at least one of the flow rate, the at least one heat transfer coefficient, and the combined thermal response of at least a portion of the cooled part to at least one baseline value to determine whether a thermal performance of the cooled part is satisfactory.

21. The system of claim 20, wherein the thermal monitoring device comprises an infrared detection device.

22. The system of claim 20, further comprising a controller configured to control and automate movement of the thermal monitoring device.

23. The system of claim 20, wherein the processor is further configured to evaluate a rate of change of thermal performance of the cooled part to determine whether the thermal performance of the cooled part is satisfactory.

24. A system for thermal inspection of a respective plurality of cooled parts installed in a turbine engine, the system comprising:
a thermal monitoring device configured to detect a plurality of surface temperatures, either directly or indirectly, of each of the cooled parts corresponding to a transient thermal response of each of the cooled parts, wherein the transient thermal response results from operation of the turbine engine; and
a processor configured to:
determine based upon the transient thermal responses one or more of:
a flow rate of a fluid flowing through one or more film cooling holes in each of the cooled parts during operation of the turbine engine,
at least one heat transfer coefficient for one or more internal passages in each of the cooled parts, and
a combined thermal response for each of the cooled parts; and
compare at least one of the flow rate, the at least one heat transfer coefficient, and the combined thermal response of at least a portion of each of the cooled parts to at least one baseline value to determine whether a thermal performance of each of the cooled parts is satisfactory.

25. The system of claim 24, wherein the thermal monitoring device comprises an infrared detection device.

26. The system of claim 24, further comprising a controller configured to control and automate movement of the thermal monitoring device.

27. The system of claim 24, wherein the processor is further configured to evaluate a rate of change of thermal performance of each of the cooled parts to determine whether the thermal performance of each of the cooled parts is satisfactory.
